(19) United States
(12) Patent Application Publication
(10) Pub. No.: US 2004/0075238 A1
(43) Pub. Date: Apr. 22, 2004

(54) Sliding foot for freestyle bicycle riding

(76) Inventors: John Charles Speegle, Huntington Beach, CA (US); David L. Edgar, Long Beach, CA (US)

Correspondence Address: MARK O. LOFTIN, 1990 BRADSHIRE DR., MOBILE, AL, 36695, US

(21) Appl. No.: 10/272,259

(22) Filed: Oct. 17, 2002

(51) Int. Cl. B62H 1/00

(52) U.S. Cl. 280/288.4

(57) ABSTRACT

A sliding foot for mounting to the underside of a bicycle to assist the rider in performing certain types of acrobatic stunts. The foot is mounted to the bicycle frame directly below the main pedal hub and extends down toward the ground in the space between the front and back wheels. The foot is comprised of a rigid structural member to which a surface engaging member is attached. The rigid structural member may be welded directly to the underside of a bicycle's frame members or may be attached thereto by a plurality of clasps. The surface engaging member is essentially a narrow, elongated piece of material, preferably a durable thermoplastic, secured to the bottom of the rigid structural member and provides the rider with a contoured lower side, with rounded edges, on which to engage objects while riding. The surface engaging member is easily removed and replaced if damaged after repeated contacts with harsh surfaces. The contoured lower side may be presented as essentially flat with round edges, a plurality of curved surfaces with round edges or a plurality of wheels in an in-line configuration, each providing the rider with different performance characteristics.

### FIELD OF THE INVENTION

This invention relates to freestyle bicycles, or bicycles designed for performance of certain types of acrobatic stunts. Such bicycles can be equipped with special attachments to either protect the bicycle's critical components during certain maneuvers or enhance the rider's ability to perform certain maneuvers. One such attachment presented here is a small narrow beam horizontally mounted beneath the pedal hub projecting downward between the wheels but sufficiently above the ground to prevent interference with normal motion of the bicycle. This device is intended to assist the rider in supporting and stabilizing the bicycle when it is poised stationary on an object or sliding along some object encountered in the rider's environment.

### BACKGROUND OF THE INVENTION

One particularly enjoyable aspect of freestyle cycling is the creative interaction of the cyclist and cycle with various obstacles encountered in the riding environment. Particularly, today's freestyle riders look for objects such as rails, steps, logs, tables, platforms, etc. upon which to momentarily support the rider and cycle. The origin of modern idea to perform these types of maneuvers on bicycles may have been largely adapted from similar maneuvers performed by skateboarders. Both skateboarders and cyclist commonly refer to these types of maneuvers as “grinding.”

The object of such maneuvers is to demonstrate the creativity of the rider in 1) discovering and selecting navigable objects in the environment, 2) electing a particular type of technique to poise the cycle upon such objects, and 3) successfully engaging and disengaging the cycle upon such object in a controlled and sustained manner.

Many factors affect the ability of modem freestyle cyclists to successfully accomplish these types of maneuvers. For example, the skill of the rider, the weight of the cycle, the elevation and texture of the surface to be engaged upon, the approach velocity, and the location of part of the cycle coming in contact with the engaging surface relative to the bicycle's center of gravity are all critical factors to these types of maneuvers. As it relates to the bicycle itself, the technology has proceeded along the lines of creating accessories which can be affixed to the bicycle to either protect the cycle from damage (example, front sprocket and chain guards) or provide an alternative platform to support the cycle while on certain objects (example, footpegs on the wheels).

However, accessories such as chain and sprocket guards are designed to prevent damage to the cycle's components but are not optimally designed to stabilize the rider while engaging objects in the riding environment. Secondly, these types of guards often become damaged because they are not designed to withstand the repeated impacts with harsh surfaces.

Many cyclists, in an attempt to avoid damaging the cycle's critical components, perform these sliding maneuvers using footpegs mounted on the wheels. However, sliding on these type members often requires the rider to drastically alter his center of gravity to maintain balance when engaging a surface with an accessory mounted on or near the wheels. Having to alter the rider's center of gravity to compensate for pivoting about a point on or near the wheels severely limits the types of maneuvers that can be successfully performed.

Despite these limitations in the prior art, many modem freestyle cyclists also continue to perform these sliding maneuvers using the bicycle's pedal sprocket and chain to engage various objects. Since neither of these parts of the bicycle is designed to withstand the forces generated by the rider's sudden impact with environmental objects, they quickly become damaged and lead to costly repairs.

What is needed in the art is an accessory, such as described herein, that can be easily mounted near the natural center of gravity of the cycle, that is shaped to optimize stability of rider when engaging certain surfaces, and that is structurally strong enough to protect the bicycle's critical components and withstand repeated impacts with harsh surfaces. Moreover, if the accessory does become damaged, the surface engaging portion can be replaced or even changed to provide different performance characteristics.

The accessory herein described represents a much better addition to the stunt cycle and will dramatically improve the ability of the cyclist to successfully perform these types of sliding maneuvers across a much broader variety of potential surfaces. Nothing in the prior art of accessories designed aid stunt cyclists in performing maneuvers is seen to describe the instant invention as claimed.

### SUMMARY OF THE INVENTION

The invention claimed here relates to a bicycle accessory that is either permanently or temporarily attached to the underside of a bicycle frame below the pedal hub. This accessory provides a stunt cyclist with a narrow beam or “foot” below the pedals from which the cyclist can use to support the bicycle while performing certain types of stunts. Weight and shock loads created by the cyclist while engaging various environmental objects are directly transmitted to sturdy bicycle frame components providing both support and protection for critical bicycle components. This accessory is substantially comprised of a rigid frame with a surface engaging lower portion mounted thereto. The rigid frame can be made of any material that provides sufficient tensile strength to withstand the forces generated by contact with various objects. This rigid frame can either be permanently welded to the underside of the bicycle or attached thereto using bolts and specially-designed clasps. The surface engaging lower portion can also be made of any material sufficiently durable enough to withstand repeated contact with objects in the cyclist's environment. This surface engaging lower portion is attached to the rigid frame in a manner that allows it to be easily replaced if damaged during stunt maneuvers and can be either flat or curved to provided different performance characteristics. In one variant of the embodiment, the surface engaging lower portion is comprised of a plurality of wheels in an in-line configuration for providing a different performance characteristic.

An object of the present invention is to provide a sufficiently strong frame which can support the bicycle and rider, withstand repeated contacts with hard surfaces, translate the forces generated to the bicycle's frame members and protect the critical parts of the bicycle, such as the chain and main pedal sprocket, from damage while the cyclist is performing various jumping stunts.

A second objective of the present invention is to provide a support member that is securely attached to the under side of bicycle, approximately below the center of gravity of the cyclist so that the rider can more easily balance upon and disengage from various objects encountered in the riding environment.

A third object of the present invention is to provide the stunt cyclist with an accessory that can be customized to provide a range of unique performance characteristics and significantly enhance the stunt cyclist's riding experience.

In order to accomplish the foregoing objectives, the inventors provide a rigid frame member that is fabricated from a single piece of metal having one flat bottom side to connect to a detachable surface engaging member and one angled top side shaped to conform to the underside of a bicycle's frame below the pedal hub. This rigid frame may be attached to the underside of the bicycle either permanently by welding or by use of a sufficiently strong attachment means. The inventors also provide herein one such attachment means comprising a forward means attaching the rigid frame to the bicycle's tubular frame member extending form the pedal hub to the handle bars and a rear attachment means attaching the rigid frame to the bicycle's frame member extending laterally from the pedal hub to the rear wheel. The detachable surface engaging member has two functional aspects comprising a top side for attaching the member to the rigid frame and a lower side of specific shape to engage objects in the rider's environment. The inventors present herein one such mean for attaching this member using a groove that is approximately the same width as the rigid frame's thickness and a plurality of screws to hold it in place. The inventors also provide herein three such variations for the object contacting lower side of said surface engaging member. Variation one is a flat, narrow beam with rounded edges. Variation two is a beam with one or more concave sections and rounded edges. Variation three is a plurality of wheels in an in-line configuration.

This invention possesses many other advantages and has other objects which may be made more clearly apparent from a consideration of the preferred embodiment of the invention shown and described.

### DESCRIPTION OF THE DRAWINGS

A detailed description of the invention will be made with reference to the accompanying drawings wherein like numerals and letters designate corresponding parts in the several figures.

FIG. 1 shows a typical bicycle frame with the sliding foot attached and extending below the pedal hub assembly.

FIG. 2 shows an exploded view of the sliding foot shown in FIG. 1. This embodiment comprises of a rigid frame and a flat surface engaging member attached thereto using a plurality of machine screws.

FIG. 3 show a view of a typical bicycle frame with the sliding foot attached to the bycycle's frame members using a forward and rear attachment means.

FIG. 4 shows an exploded view of the sliding foot shown in FIG. 3, to better demonstrate the components comprising the forward and rear attachment means.

FIG. 5 shows a cross sectional view of the claimed forward attachment means.

FIG. 6 shows a cross sectional view of the claimed rear attachment means.

FIG. 7 shows a side view of an alternate embodiment of the surface engaging member where the object-contacting lower surface has two concave sections to provide different performance characteristics.

FIG. 8 shows a side view of still another alternate embodiment of the surface engaging member where the object-contacting lower surface is fitted with a plurality of wheels in an in-line configuration to provide different performance characteristics.

### DETAILED SPECIFICATION

The following detailed description is of the best presently contemplated mode of carrying out the invention including the most preferred variations that define the inventions usefulness. This description is not to be taken in a limiting sense, but is made merely for purposes of illustrating the general principles of the invention and the scope of the invention being defined by the appended claims

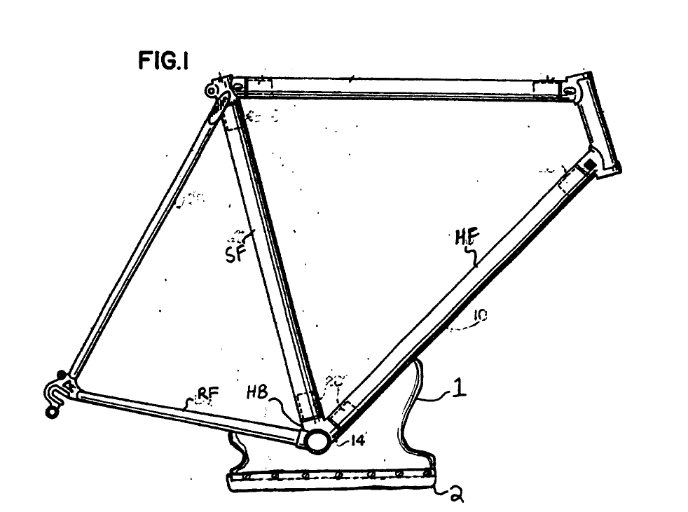

A basic bicycle frame is shown in FIG. 1 with the sliding foot of the present invention attached thereto. This basic bicycle frame is comprised substantially of the pedal crank hub HB, a rear wheel support member, RF, attached to the hub HB and extending substantially laterally therefrom, a second seat support member, SF, attached to the hub HB and extending substantially upward therefrom, and a third forward support member, HF attached to the hub HB and extending angularly upward. For a typical bicycle frame, the rear wheel support member, RF consists of two substantially identical tubular members connected on one end to the pedal crank hub, HB that extend laterally away from the hub on either side of the rear wheel.

The third support member, HF generally consists of a tubular metal member which extends from the hub, HB and connects to other bicycle frame members near the handle bars. The angle this frame member makes relative to the rear wheel support member, RF, its general size and shape vary widely depending on the style of the bicycle frame. The claimed invention can easily be modified to accommodate this variety and the embodiment presented in the claims relates to the most common type of bicycle frame.

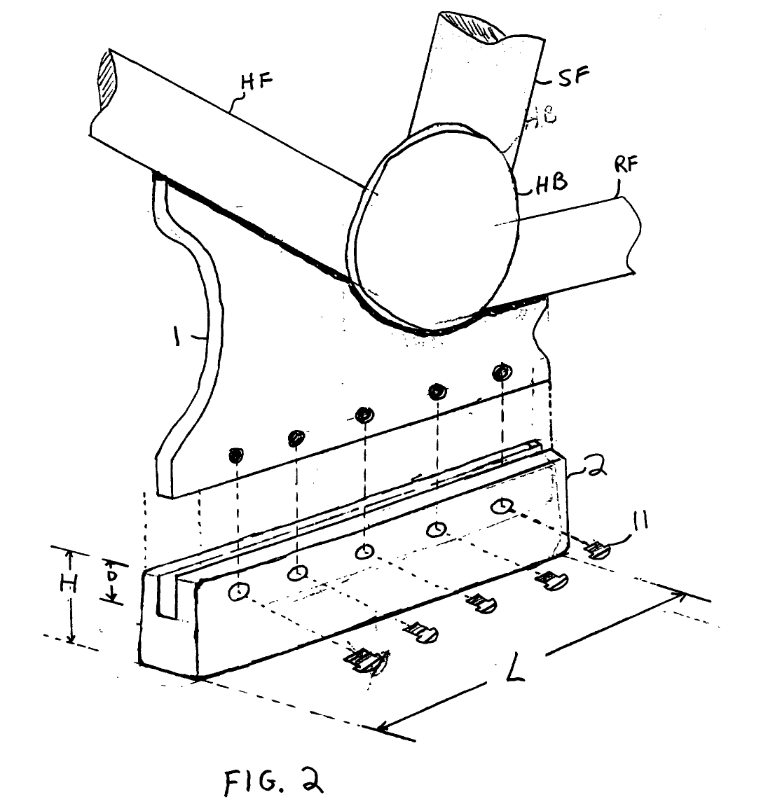

As shown in the Figures, the present invention relates to a sliding foot that is comprised of a rigid frame 1 and surface engaging member 2 attached to the underside of the bicycle frame below the pedal hub HB and projecting downward underneath the bicycle. FIG. 2 shows an exploded view of the claimed sliding foot attached to the basic bicycle frame members, HF, RF and pedal hub HB by welding. The sliding foot assembly extends below the bicycle in the space between the pedal hub, HB and the ground. The distance below the pedal hub, HB may vary depending on the desired performance characteristics but is limited in that the sliding foot must not interfere with the normal locomotion of the bicycle while not engaging objects of performing stunt maneuvers. The inventors prefer the underside of the surface engaging member to extend approximately 4 to 6 inches below the bottom of the pedal hub HB.

Attached to the bottom side of the rigid frame 1 is a surface engaging member 2. The surface engaging member shown in FIG. 2 is comprised of a solid piece of durable material in which a groove is cut lengthwise into the center of the top side to receive the bottom side of the rigid frame, 1. The inventors prefer the surface engaging member be fabricated from a durable thermoplastic, such as high-density polyethylene (HDPE), polyvinylidine diflouride (PVDF), tetraflouroethylene (Teflon) and others. Non-plastic materials, such a wood, fiber composite, metal or other machineable material could also be used provided it has the tensile strength and durability necessary to withstand the forces generated by repeated contacts with harsh surfaces by the bicycle and rider while performing stunts. The depth, D of the groove cut into the topside of this surface engaging member must be sufficient to accommodate the plurality of machine screws 11 and to adequately distribute the lateral forces imposed onto the bottom side to the rigid frame, 1. This required depth will depend on the tensile strength of the surface engaging member material. For a thermoplastic, such as high-density polyethylene (HDPE), the preferred depth D is between ½ and ¾ of an inch.

The overall length L of the surface engaging member as shown in FIG. 2 is ultimately limited by the available distance between the front and rear wheels of the bicycle. It is conceivable that a sliding foot of the present invention could be made to extend to this maximum available distance. However, the inventors present the preferred embodiment herein where the length, L of the surface engaging member is between 8 and 14 inches.

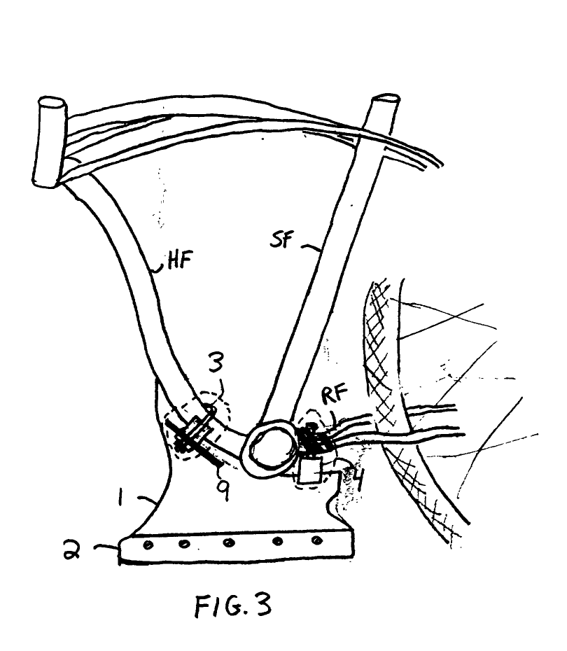

As shown in FIGS. 1 and 2, the most preferred and structurally sound means of attaching the rigid frame 1 to the bicycle frame members is by welding of the top edge of the rigid frame to the underside of the bicycle frame members HF and HB. Alternatively, as shown in FIG. 3, the rigid frame can be attached to the bicycle using a suitably strong attaching means. The inventors present herein one such means of attachment using a forward attachment means 3 and a rear attachment means 4. The strength and adaptability of the forward attachment means is enhanced by machining a groove 9 into the rigid frame.

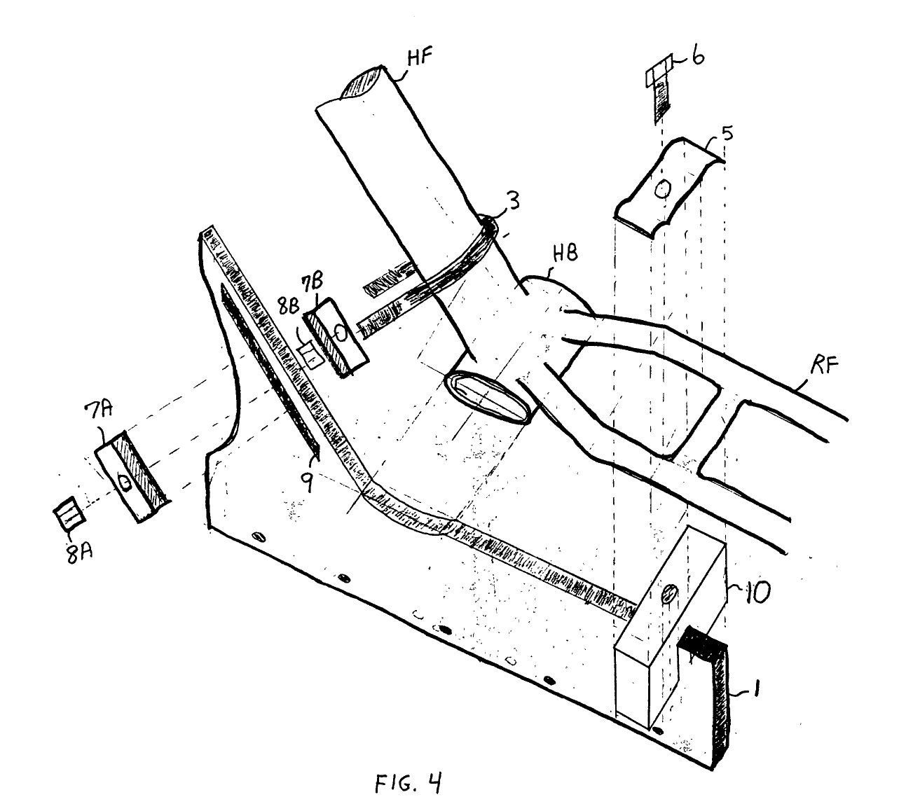

FIG. 4 shows an exploded view of the sliding foot's rigid frame, forward and rear attachment means, and the bicycle frame members to which the sliding foot attaches. The forward attachment means is comprised of a u-bolt 3, two locking nuts 8A and 8B, and two forward clasps 7A and 7B. The rear attachment means is comprised of a clasp, 5 a machine bolt 6, and an attaching block 10. The forward attachment means binds the rigid frame to the bicycle's tubular forward support frame member, HF. The rear attachment means binds the rigid frame to the rear wheel support member, RF.

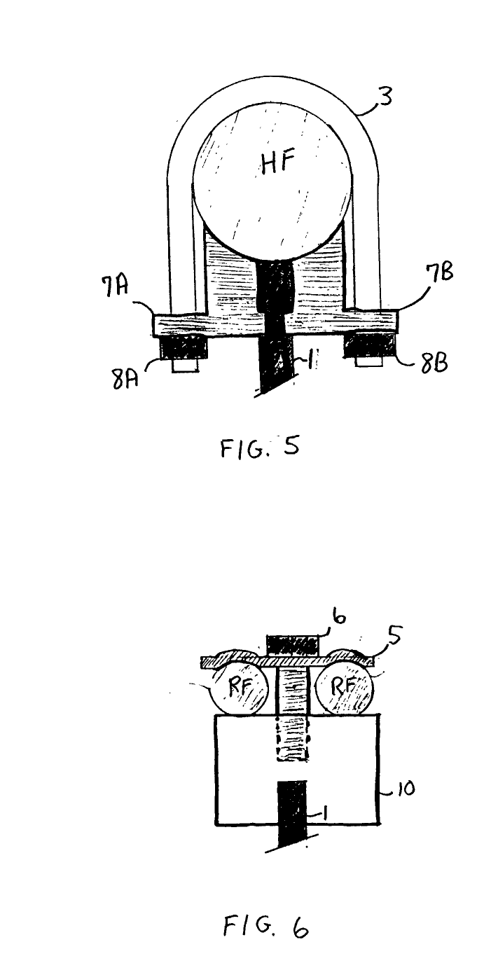

FIG. 5 shows a cross-sectional view of the forward attachment means from a view that is axial to the bicycle's forward support frame member, HF. The u-bolt 3 circumscribes the top hemisphere of the tubular-shaped forward support frame, HF with its threaded ends projecting through holes drilled into the forward clasps 7A and 7B. On each of the u-bolt's threaded ends, a self-locking nut is attached and tightened to provide the binding force for the assembly against the sliding foot's rigid frame 1 and forward support frame HF.

As best seen in FIG. 5, the forward clasps 7A and 7B of the forward attachment means are identical and can be fabricated from steel, aluminum or other rigid metal. These forward clasps are comprised of a top side that is shaped to approximately conform to the tubular contour of the outside surface of the forward support frame member HF, a flat bottom side for engaging the locking nut, and an inner side with a notch for engaging a groove 9 in the rigid frame 1.

As best seen in FIG. 6, the rear attachment assembly is comprised of a machine bolt 6, a rear clasp 5 and an attaching block 10. The rear clasp 5 has two concave sections shaped to approximate the tubular contour of the rear wheel support frame members RF. The attaching block is comprised of an underside which is notched to receive the sliding foot's rigid frame 1 and a top side that is tapped and threaded to receive the machine bolt 6.

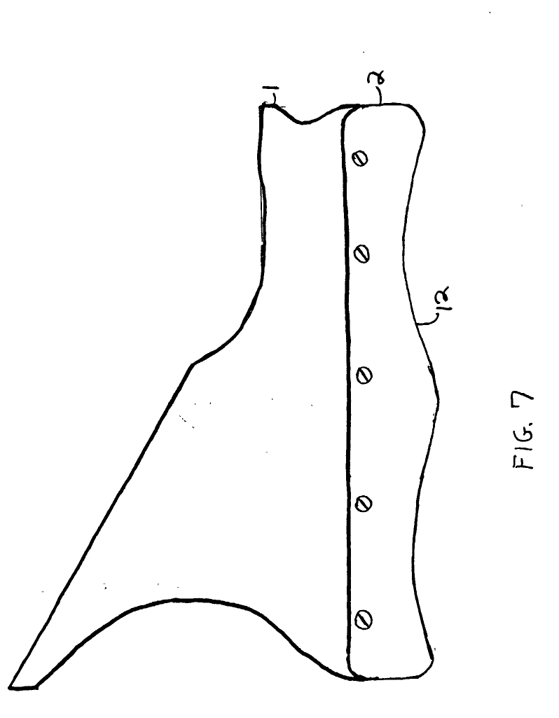

The underside of the surface engaging member 2 can be modified in a variety of ways so as to provide different performance characteristics. FIG. 7 shows one such variation where the object-contacting lower portion 12 contains a plurality of concave surfaces on which the stunt cyclist can alter the response of the sliding foot when engaging various objects within the riding environment.

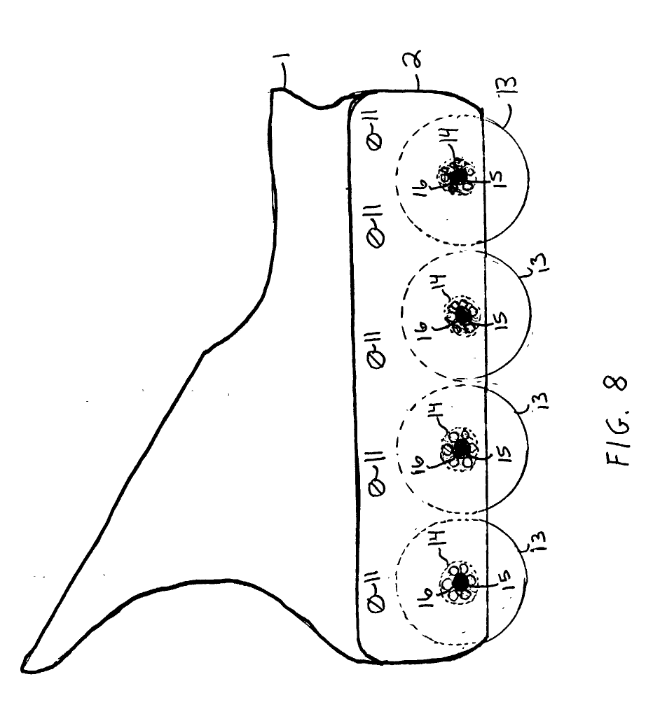

FIG. 8 shows still another variation in which the object contacting lower portion is fitted with a plurality of wheels in an in-line configuration. In this variation, the rigid frame 1 is identical to that shown in the Figures. The in-line wheel assembly adapted to the surface engaging member 2 is typical of that known in the prior art, which basically consists of a urethane wheel 13 in formed around an axel and bearing assembly 14. Each wheel is held in place by a locking pin assembly which passes through a hole drilled into the surface engaging member 2 and passes through the axial center of axel and bearing assembly. The locking pin is threaded on one end to which is attached a nut to secure the assembly in place. To provide a means of preventing wear and elongation of the hole drilled into the surface engaging member for receiving the locking pin, a steel cylinder 16 is placed inside the hole on either side of the roller wheel.

While this variant of the invention has been shown as embodied in a four wheeled skate, it should be understood that more or less wheels may be used to provide different performance characteristics. All such variations are within the purview of the invention.

While the preferred embodiments of the present invention have been described, be understood that various changes, adaptations and modifications may be made without departing from the spirit of the invention and the scope of the appended claims.

1. A sliding foot for permitting a bicycle rider to perform stunts, comprising:
(a) a rigid frame attached to the underside of the bicycle extending below the pedal hub between the wheels,
(b) a surface engaging member attached to the bottom of said rigid frame having an upper side for receiving said rigid frame and an object contacting lower side.

2. A sliding foot of claim 1, wherein said rigid frame is comprised of
(a) a solid metal plate of sufficient thickness to support the weight of the bicycle and rider when engaging various objects during stunt maneuvers,
(b) a top side cut to approximate the angle made between a bicycle's frame members extending upwardly and laterally from the bicycle's pedal hub,
(c) a flat bottom side for attachment of a surface engaging member.

3. A sliding foot of claim 1, further comprising
(a) a forward attachment means connecting said rigid frame to the bicycle's frame member extending upwardly from the pedal hub to the handle bars,
(b) a rear attachment means connecting said rigid frame to the bicycle's frame member extending laterally from the pedal hub to the rear wheel

4. A sliding foot of claim 2, wherein said rigid frame further comprises a narrow groove machined into said metal plate on each side for receiving an adjustable forward attachment means.

5. A sliding foot of claim 3, wherein said forward attachment means further comprises two identically machined blocks of metal for holding the forward portion of said rigid frame to the bicycle's frame member extending upwardly from the pedal hub to the handle bars wherein said blocks of metal each having
(a) a top side approximating the contour of the upwardly extending bicycle frame member,
(b) a lateral side comprising a flat surface to engage the side of said rigid frame and a rectangular protrusion to engage a narrow groove cut into said rigid frame member,
(c) a flat bottom side for supporting a nut,
(d) a whole drilled from said top side through to said bottom side for receiving a threaded u-bolt.

6. A sliding foot of claim 3, wherein said rear attachment means is comprised of a block of metal, binding clasp and retaining bolt for holding the rear portion of said rigid frame to the bicycle's tubular frame members extending laterally from the pedal hub to the rear wheel.

7. The sliding foot of claim 1, wherein said surface engager is fabricated from a solid piece of thermoplastic, fiber composite, wood or metal and is further comprised of
(a) a topside with a narrow groove running lengthwise to receive said rigid frame,
(b) an object contacting lower side that is substantially flat with rounded edges,
(c) an attaching side containing a plurality of holes to receive screws to bind said surface engager to said rigid frame.

8. The sliding foot of claim 7, wherein said surface engager's object-contacting lower side contains one or more concave sections to alter the sliding characteristics of the foot.

9. The sliding foot of claim 1, wherein said surface engager is fabricated from a solid piece of thermoplastic, fiber composite, wood or metal and is further comprised of
(a) a topside with a narrow groove running lengthwise to receive said rigid frame,
(b) an object-contacting lower side that is grooved to receive a plurality of wheels centered on a common plane, each said wheel having a central axis being perpendicular to said common plane
(c) a plurality of wheel and axles with said axels being positioned on said central axis of each wheel and each wheel including a bearing means attached to said wheel axles for reducing rotational friction about said axles,
(d) a means of attaching said plurality of wheels to the surface engager,
(e) an attaching side containing a plurality of holes to receive screws to bind said surface engager to said rigid frame.
